(19) United States
(12) Patent Application Publication
(10) Pub. No.: US 2012/0108172 A1
(43) Pub. Date: May 3, 2012

(54) PERSONAL DIGITAL CONTEXT

(75) Inventor: Geoffrey Norman Bullen, Copenhagen (DK)

(73) Assignee: MICROSOFT CORPORATION, Redmond, WA (US)

(21) Appl. No.: 12/916,087

(22) Filed: Oct. 29, 2010

(51) Int. Cl. H04B 7/00

(52) U.S. Cl. 455/41.2

(57) ABSTRACT

A personal digital context may be provided. A context element may be identified and used to update a context state associated with a user. Upon determining that a context-aware device is available, the context state may be provided to the context-aware device.

### BACKGROUND

A personal digital context is a data structure that allows the storage, manipulation, and sharing of a user's digital information across connected devices. Unlike a user's physical context (e.g., thoughts, mood, etc.), current technology has no way to carry around a user's digital context. Conventional systems, therefore, have no way to react to a user's digital context in the same way that people can react to another's physical context. Thus, devices and systems can present only general options and responses to people rather than allowing the creation of a more personalized experience.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A personal digital context may be provided. A context element may be identified and used to update a context state associated with a user. Upon determining that a context-aware device is available, the context state may be provided to the context-aware device.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIGS. 2A-2C are block diagrams illustrating manual provision of a context to a context-aware device;

FIG. 3 is a flow chart of a method for providing a personal digital context; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A personal digital context may be provided. Such a context may comprise personal information about a user, such as their name, address, and occupation as well as a log of recent activity such a phone call made and received, web browsing history, and/or places visited. This context may be carried around on a mobile device, such as a laptop, tablet, or cellular phone, and shared with other context-aware devices such as the user's home or work computers and/or public devices, such as retail store terminals. For example, a user may elect to share their personal digital context with a large wall screen for display and interaction, or with a terminal at a book store to receive a recommendation of which new releases may be of interest.

Consistent with embodiments of the invention, a user's context may be shared among devices and/or services. For example, a user's context may comprise information such as a time and date, the user's location, and a recent web browsing history. A cloud service such as a shopping service that tracks prices, may receive the user's context from their mobile phone and review context elements such as the fact that the user is currently in Aspen, Colo., but has a home address in San Francisco and has been researching snow board models on their web browser. The cloud service may then be able to provide the user with a list of snow board rental locations along with current inventories of the viewed models and a price comparison based on the received context.

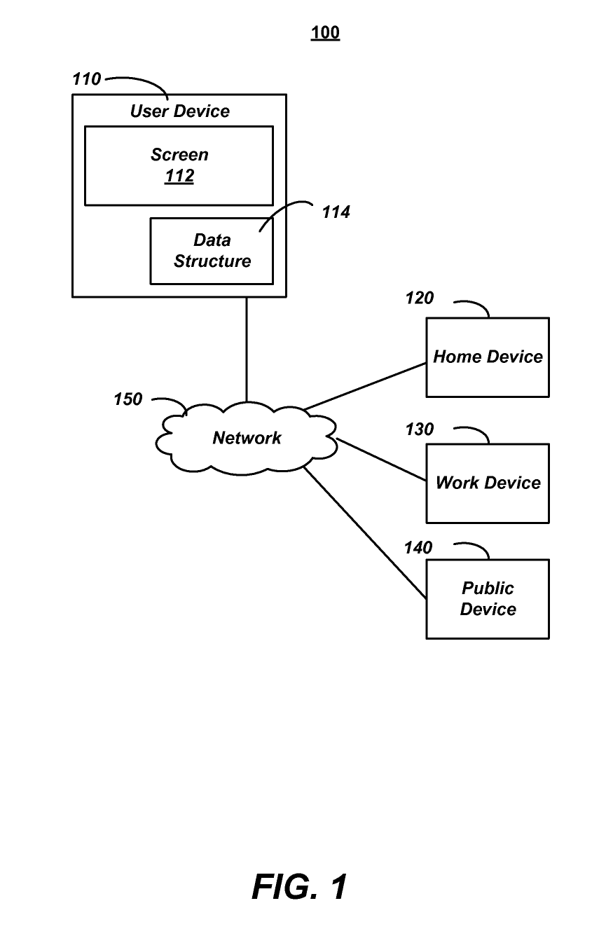

FIG. 1 is a block diagram of an operating environment 100 comprising a user device 110 comprising a screen 112 and an internal memory 114 comprising a context state data structure 116, a home device 120, a work device 130, a public device 140, and/or a cloud service 145. Each of the above devices and/or services may be communicatively coupled via a network 150, such as a wireless data network, a wired data network, and/or a cellular data network. Consistent with embodiments of the invention, some devices and/or services may be operative to communicate via more than one network. For example, user device 110 may comprise a mobile device, such as a cellular phone, operative to communicate via a wireless network and a cellular data network. Further consistent with embodiments of the invention one and/or more of the devices may comprise a radio frequency identification (RFID) tag and/or an RFID reader that may comprise a communications network between those devices.

Each of devices 110, 120, 130, and 140, along with cloud service 145, may be operative to create, modify, receive, send, share and/or operate on context state data structure 116. Multiple copies of a user's context state may be maintained, in accordance with applicable privacy policies. For example, a context may be created by cloud service 145, transmitted to user device 110, updated throughout the day via sharing back and forth with work device 130, and then sent to home device 120 at the end of the day where the user's home context may be updated according to the latest version as provided by user device 110.

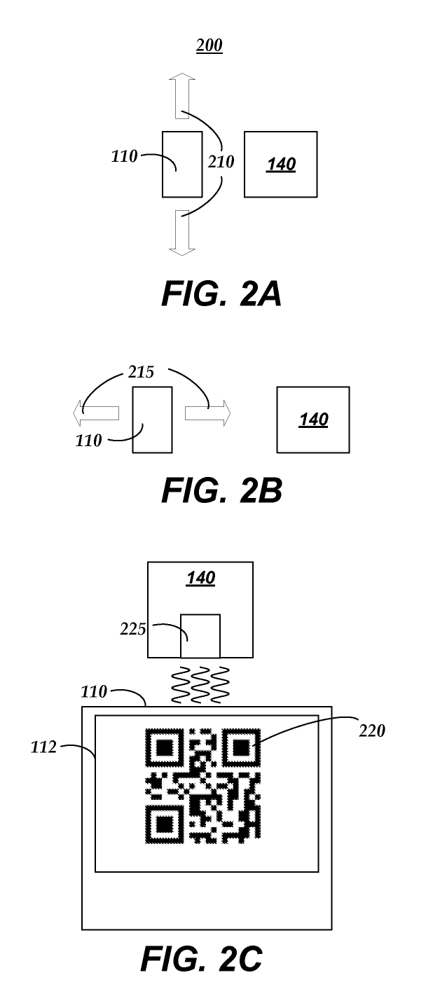

FIG. 2A is a block diagram of a swipe motion operative to identify a context-aware device, such as public device 140, to user device 110. The swipe motion may comprise an upward and/or downward motion 210 in the proximity of the context-aware device that may be detected, for example, by a gyroscope and/or similar component associated with user device 110.

FIG. 2B is a block diagram of a second swipe motion operative to identify a context-aware device, such as public device 140, to user device 110. The swipe motion may comprise a leftward and/or rightward motion 210 in the proximity of the context-aware device that may be detected, for example, by a gyroscope and/or similar component associated with user device 110.

FIG. 2C is a block diagram of a code-reading action operative to identify a context-aware device, such as public device 140, to user device 110. The code-reading action may comprise displaying a barcode and/or a data-matrix code 220 on screen 112 generated by user device 110 to a code reader component 225 of public device 140. The generation and reading of barcodes and data-matrix codes (e.g., QR code®, Aztec code, MaxiCode, and Semacode) are well known in the art. The code may comprise all or a portion of context state data structure 114.

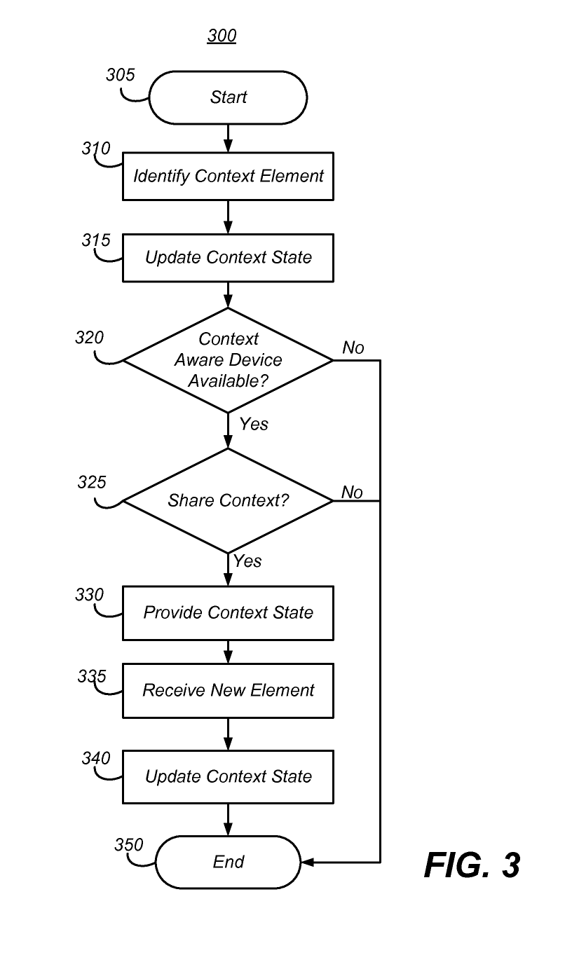

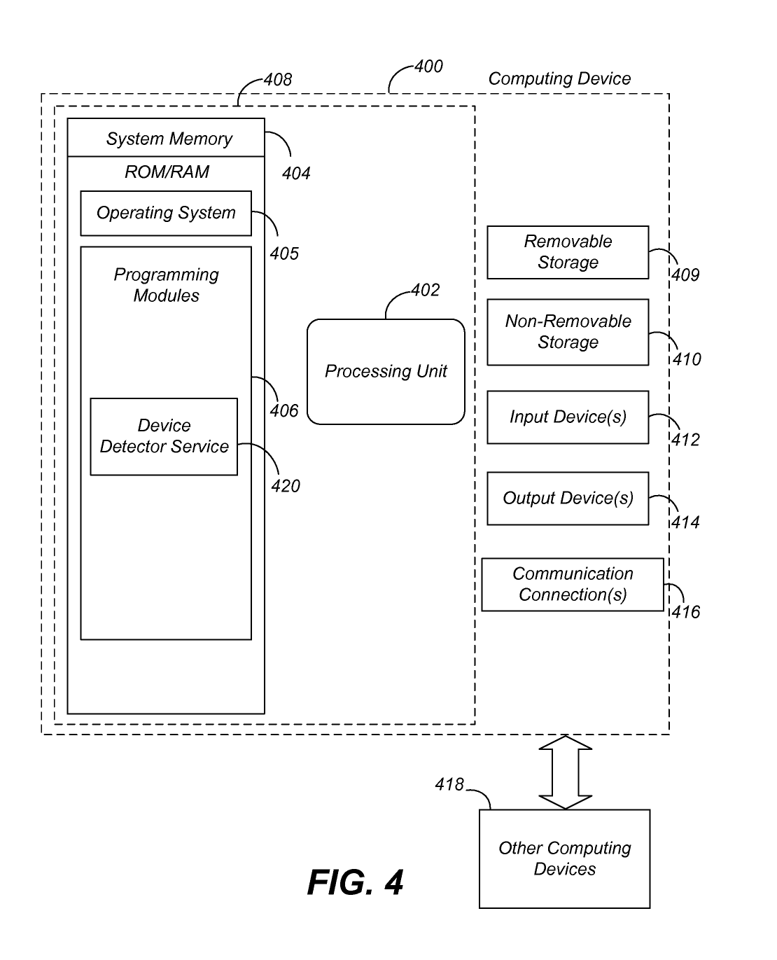

FIG. 3 is a flow chart setting forth the general stages involved in a method 200 consistent with an embodiment of the invention for providing can ERP context-aware environment. Method 300 may be implemented using a computing device 400 as described in more detail below with respect to FIG. 4. Ways to implement the stages of method 300 will be described in greater detail below. Although described in the below embodiments as a communication from a user's personal device to devices and services associated with other users and/or organizations, this is for example purposes only. In some embodiments, the communication may be bi-directional, allowing contexts created on other devices and/or services to be provided to the user's personal device and/or among the other devices and services. Method 300 may begin at starting block 305 and proceed to stage 310 where computing device 400 may identify a context element associated with a user. For example, user device 110, which may comprise a mobile device such as a cell phone, may identify a communication made by a user, such as a phone call or text message to another contact.

The context element may also comprise, for example, a location of the user, an application action requested by the user, a time, a date, a presence of at least one other user, a communication received by the user, a physical activity of the user, a location change by the user, and a reminder associated with the user. The location of the user may be identified, for example, via GPS location and/or a location identifier broadcast by a context-aware device such as public device 140. The presence of another user may be identified by detecting the presence of the other user's context-aware device, such as via communication network 150 and/or analysis of a calendar associated with the user that identifies a current appointment and other attendees. Application action requests may comprise, for example, productivity application tasks such as editing a word processing document and/or web searches conducted on a web browser application.

From stage 310, method 300 may advance to stage 315 where computing device 400 may update a context state associated with the user, wherein the context state is stored on a mobile device associated with the user. For example, the context state may be stored as data structure 114 on user device 110. An outgoing communication made by the user may be added to the stat structure as a recent activity, for example, and may comprise associated details such as who the communication was with, a subject of the communication, a time/date, and/or a duration.

From stage 315, method 300 may advance to stage 320 where computing device 400 may determine whether a context-aware device is available at a current location of the user. For example, user device 110 may detect a broadcast signal from public device 140 via network 150. The broadcast signal may comprise, for example, a radio frequency identification (RFID) signal, a cellular network data signal, and/or a wireless network data signal. For another example, the user may manually identify the context-aware device to user device 110, such as by creating a physical connection (e.g., USB and/or other cabled connection) and/or by performing an action such as swipe actions 210, 215 described above with respect to FIGS. 2A-2B and/or scanning a barcode displayed on user device 110 via barcode reader 220 of public device 140 as described above with respect to FIG. 2C. If no context-aware device is available, method 300 may end at stage 350.

From stage 320, method 300 may advance to stage 325 where computing device 400 may, in response to determining that the context-aware device is available at the current location of the user, determine whether the context state is to be shared with the context-aware device. For example, user device 110 may provide a notification to the user comprising an identification of the context-aware device and request authorization to provide the context state to the context-aware device. The authorization may be entered by the user, for example, in the form a selection of an “accept” button and/or in the form of a password. The context-aware device may comprise a pre-authorized device, such as a device for which authorization has previously been requested and received to share the user's context state and/or may belong to a category of context-aware devices, each of which are authorized to receive at least a portion of the user's context state. For example, the user may have authorized context-aware devices associated with a particular chain of retail stores and/or restaurants to be provided with details from the user's context state related to previous visits and/or purchases.

Consistent with embodiments of the invention, manual identification of the context-aware device, as described above with respect to stage 315, may be treated as an implicit authorization by the user to provide at least a portion of the context state to the context-aware device. Such context-aware devices may result in a further authorization request regarding the amount and/or type of data from the user's context state that may be provided to the context-aware device. If no authorization is received, method 300 may end at stage 350.

If authorization is received at stage 325, method 300 may advance to stage 330 where computing device 400 may provide the context state to the context-aware device. For example, at least a portion of data structure 114 may be transmitted via network 150 from user device 110 to the context-aware device, such as home device 120, work device 130, and/or public device 140.

From stage 330, method 300 may advance to stage 335 where computing device 400 may receive a new context element from the context-aware device. For example, public device 140 may be associated with a restaurant location and may have received purchase history context information from user device 110. Public device 140 may provide a new context element to user device 110 in the form of information associated with the user's most recent order (e.g., today the user ordered a latté at the coffee shop).

From stage 335, method 300 may advance to stage 340 where computing device 400 may update the context state according to the new context element. For example, data structure 114 may have the new context element appended and/or the new context element may replace an older datum within the structure. Method 300 may then end at stage 350.

An embodiment consistent with the invention may comprise a system for providing a context-aware environment. The system may comprise a memory storage and a processing unit coupled to the memory storage. The processing unit may be operative to identify a context element, update a context state associated with a user according to the context element, determine whether a context-aware device is available, and, if so, provide the context state to the context-aware device. The context state may be provided automatically and/or may require authorization from a user before being provided. Upon receiving a response to the authorization request from the user, the processing unit may be further operative to create a device record associated with the context device comprising the identification of the context-aware device and the response to the authorization request. This may allow automatic provision of the context state the next time the presence of that context-aware device is detected.

Another embodiment consistent with the invention may comprise a system for providing a context-aware environment. The system may comprise a memory storage and a processing unit coupled to the memory storage. The processing unit may be operative to identify a context element associated with a user, update a context state associated with the user, identify the presence of a context-aware device, and determine whether the context state is to be shared with the context-aware device. If so, the processing unit may be operative to provide the context state to the context-aware device.

The processing unit may be further operative to display at least a summary of the context state, receive an edit to the context state from the user, and update the context state according to the edit. For example, the context state may be associated with the user's purchases at a particular retailer. The processing unit may be operative to display a list of those purchases and receive modifications, such as corrections and/or deletions, of individual purchases, such as when the context state is used to provide recommendations for future purchases in line with user's previous purchases and the user wishes to remove an item purchased as a gift for someone else.

Yet another embodiment consistent with the invention may comprise a system for providing a context-aware environment. The system may comprise a memory storage and a processing unit coupled to the memory storage. The processing unit may be operative to identify a context element associated with a user, update a context state associated with the user, wherein the context state is stored on a mobile device associated with the user, determine whether a context-aware device is available at a current location of the user, in response to determining that the context-aware device is available at the current location of the user, determine whether the context state is to be shared with the context-aware device, and, in response to determining that the context state is to be shared with the context-aware device, provide the context state to the context-aware device. The context element may comprise, for example, a location of the user, an application action requested by the user, a time, a date, a presence of at least one other user, a communication made by the user, a communication received by the user, data provided by an application, a physical activity of the user, a location change by the user, and a reminder associated with the user. The processing unit may be further operative to receive at least one second context element from the context-aware device and update the context state according to the received at least one second element.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a certificate management module 407. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. a context-aware device detector service 420) may perform processes including, for example, one or more of method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a personal digital context, the method comprising:
identifying a context element;
updating a context state associated with a user according to the context element;
determining whether a context-aware device is available; and
in response to determining whether the context-aware device is available, providing the context state to the context-aware device.

2. The method of claim 1, wherein the context element comprises at least one of the following: a location of the user, an application action requested by the user, data provided by an application, a time, a date, a presence of at least one other user, a communication made by the user, a communication received by the user, a physical activity of the user, a location change by the user, and a reminder associated with the user.

3. The method of claim 1, further comprising storing the context-state on at least one of the following: a computer associated with the user, a mobile device associated with the user, and a cloud service storage location associated with the user.

4. The method of claim 3, wherein determining whether the context-aware device is available comprises detecting a broadcast signal from the context-aware device.

5. The method of claim 4, wherein the broadcast signal comprises at least one of the following: a radio frequency identification (RFID) signal, a cellular network data signal, and a wireless network data signal.

6. The method of claim 4, further comprising transmitting the context state to the context-aware device automatically in response to detecting the broadcast signal.

7. The method of claim 4, further comprising:
providing a notification to the user comprising an identification of the context-aware device; and
requesting authorization to provide the context state to the context-aware device.

8. The method of claim 7, further comprising:
receiving a response to the authorization request from the user; and
creating a device record associated with the context device comprising the identification of the context-aware device and the response to the authorization request.

9. The method of claim 3, wherein determining whether the context-aware device is available comprises receiving a request from the user to provide the context state to the context-aware device.

10. The method of claim 9, wherein the request from the user comprises a motion of the mobile device.

11. The method of claim 9, wherein the request from the user comprises scanning at least one of the following: a barcode and a data-matrix code.

12. A computer-readable medium which stores a set of instructions which when executed performs a method for providing a personal digital context, the method executed by the set of instructions comprising:
identifying a context element associated with a user;
updating a context state associated with the user, wherein the context state is stored on a mobile device associated with the user;
identifying the presence of a context-aware device;
determining whether the context state is to be shared with the context-aware device; and
in response to determining that the context state is to be shared with the context-aware device, providing the context state to the context-aware device.

13. The computer-readable medium of claim 12, wherein determining whether the context state is to be shared with the context-aware device comprises determining whether the context-aware device is authorized to receive the context by the user.

14. The computer-readable medium of claim 12, wherein determining whether the context state is to be shared with the context-aware device comprises determining whether the context-aware device is associated with a plurality of pre-authorized context-aware devices.

15. The computer-readable medium of claim 12, wherein determining whether the context state is to be shared with the context-aware device comprises determining whether the user performed an action to manually authorize providing the context state to the context-aware device.

16. The computer-readable medium of claim 12, wherein determining whether the context state is to be shared with the context-aware device comprises determining whether the context-aware device is associated with a category of pre-authorized context-aware devices.

17. The computer-readable medium of claim 12, further comprising:
receiving a second context element from the context-aware device; and
updating the context state according to the received second context element.

18. The computer-readable medium of claim 12, further comprising:
displaying at least a summary of the context state;
receiving an edit to the context state from the user; and
updating the context state according to the edit.

19. The computer-readable medium of claim 12, wherein the context element comprises at least one of the following: a location of the user, an application action requested by the user, a time, a date, a presence of at least one other user, data provided by an application, a communication made by the user, a communication received by the user, a physical activity of the user, a location change by the user, and a reminder associated with the user.

20. A system for providing a personal digital context, the system comprising:
a memory storage; and
a processing unit coupled to the memory storage, wherein the processing unit is operative to:
identify a context element associated with a user, wherein the context element comprises at least one of the following: a location of the user, an application action requested by the user, a time, a date, a presence of at least one other user, data provided by an application, a communication made by the user, a communication received by the user, a physical activity of the user, a location change by the user, and a reminder associated with the user,
update a context state associated with the user, wherein the context state is stored on a mobile device associated with the user,
determine whether a context-aware device is available at a current location of the user,
in response to determining that the context-aware device is available at the current location of the user, determine whether the context state is to be shared with the context-aware device,
in response to determining that the context state is to be shared with the context-aware device, provide the context state to the context-aware device,
receive at least one second context element from the context-aware device, and
update the context state according to the received at least one second element.
